(19) United States
(12) Patent Application Publication
(10) Pub. No.: US 2002/0073160 A1
(43) Pub. Date: Jun. 13, 2002

(54) Multi-site automatic posting and verification tool

(76) Inventor: Richard L. Purcell, Brevard, NC (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/735,324

(22) Filed: Dec. 12, 2000

(51) Int. Cl. G06F 15/16

(52) U.S. Cl. 709/206; 707/3

(57) ABSTRACT

A system that receives information from a user, posts at least part of information received on multiple Internet sites, and verifies the posted information. The system comprises a server with an e-mail agent for receiving information from the user, a document editor for checking the format of the information received, a document parser for checking the content of the information received, a queue manager for placing the information received in a queue, and a plurality of robots for placing and retrieving information from multiple web sites.

### FIELD OF THE INVENTION

The present invention relates to computer network and more particularly relates to automation of posting and verifying information on multiple computer network sites.

### BACKGROUND OF THE INVENTION

Technology has transformed our world. Traditional ways of doing business are being replaced everyday with new methods aided by new technologies. Not long ago when an employer searched for qualified workers, the employer placed an ad in a local newspaper, and he would receive resumes from qualified job seekers. The advance in transportation and communication changed the above scenario slightly: the employer can now place the ad in a newspaper of national circulation, and he will consider applicants throughout the country. Computer network, i.e. the Internet, has changed how an employer searches for qualified candidates even more.

The advent of Internet makes job-opening information available instantaneously to people all over the world who have access to a computer and a telephone line or other link. Now, an employer can place a “wanted” ad on its own web site, and all who visit the web site can view the ad. However, placing the ad on one's own web site may not be the most efficient way to advertise a job opening because the reach is limited to people who know the employer or its site. Many web sites have been developed for the job placement purpose, and job seekers can get information on job openings around the country from these specialized web sites. However, an employer who wants its ad to be seen by as many qualified job seekers as possible needs to place its ad on all the web sites frequently visited by the job seekers.

The employer that wants its job openings to be seen by as many qualified applicants as possible needs to place its job opening ads in several well known career placement web sites, such as currently available monster.com, headhunter.com, yahoo.com, etc. Each of these web sites has its own data entering format, and the format is often unique for that web site. The employer needs to visit each web site and repeatedly enters the same information onto each web site in order to post the opening. This process is laborious, time consuming, and prone to mistakes.

The employer needs to have a large staff dedicated for manual data entry if it is a large corporation with many job openings and a high turnover rate. Besides high cost of labor, the cost for training the data entry staff can also be costly. The process of manual data entry tends to result in more misspelled words, grammar errors, and cosmetic “formatting” problems. These problems cause viewing and aesthetic difficulties. In addition to these data entry problems, the manual data entry also causes delay in posting the information.

Once job opening information is posted, the employer has no easy way to verify the information has been properly posted. The employer needs to rely on the manual process to visit the career placement web sites in order to verify the posted information. Again, this manual verification process is laborious.

Applicants who want to post their resumes on different web sites face similar difficulties. To improve their chances of finding good jobs the applicants want their resumes be seen by as many potential employers as possible, and the applicants generally post their resumes on more than one career placement web site. As consequence the applicants also need to visit each web site and repeatedly enter the same information onto each web site. After posting the information, the applicants need to go through the manual process if they want to verify the posting. The posting and verification processes are manual, repetitive, laborious, and prone to errors.

### SUMMARY OF THE INVENTION

The present invention discloses, in its preferred embodiments, systems and methods for a user to post information on multiple web sites by entering the information one single time on one single web site. A system according to one embodiment of the present invention has a server supporting a web site, where users enter the information to be posted, which is accessible through the Internet. The server includes several software agents: an e-mail agent, an extensible markup language (XML) editor, an XML parser, a queue manager, a manual intervention interface (MANI), a data entry robot, a confirmation robot, and a status board. The server is accessible to users through the Internet, and can be used to post any type of information. For example, user can post an automobile for sale on different “for sale by owner” type web sites or post a recipe on different gourmet food oriented web sites. However, the posting of a job requisition is used for the purpose of this description albeit in a non limiting way.

In that respect, when a user, generally an employer seeking qualified candidates, has a job opening and wants to advertise this opening, the user accesses the server through a web site. The web site displays a web page for the user to enter the login information. After logging in, the user can select options for posting the job requisition from a menu, which may include the option for verifying postings among other options. Once the user enters the job requisition, the job requisition is placed in an inbox for further processing.

Different software agents process the job requisition in the inbox before placing it on different career placement web sites. The e-mail agent detects the job requisition available in the inbox and hands it to a XML editor. The XML editor checks the job requisition content for formatting. If the job requisition is not formatted properly, the job requisition is rejected. After checking for formatting, a XML parser continues to parse the job requisition content for valid content and/or values within defined ranges. If the job requisition content does not contain all the data or proper data, the job requisition is rejected. The XML parser submits the job requisition with proper content to a queue manager.

The queue manager acts as a “supervisor” of a staff of electronic workers or data entry robots. The queue manager places the job requisition into a “new” queue and launches an army of data entry robots to various target sites to perform data entry tasks. Data entry robots function much like a human operators and capable of visiting web sites, interpreting web pages, and automatically interacting with them. A data entry robot becomes knowledgeable of data format required for a particular web site under certain circumstances such as when it is equipped with a special task list designed for that particular web site. Each web site has its own special task list, and this special task list is updated when the web site is changed. Each data entry robot “travels” to a designated web site, logs in, and performs data entry for the job requisition. A data entry robot “travels” to a designate web site by sending a Hyper Text Transfer Protocol (HTTP) message, or other suitable message, to the web site's URL (universal resource locator) address, or the IP address, requesting data entry forms. When the data entry forms are received, the data entry robot fills out the forms with pertinent information and sends them back to the designated web site. After entering the job requisition information on the designated web site, the data entry robot informs the queue manager by updating the number of sites posted. The queue manager then dispatches a confirmation robot to check the job requisition posted. The confirmation robot functions much like a data entry robot. The confirmation robot travels to a designated web site, logs in, and performs a “lookup” to determine if the job requisition is posted. The confirmation robot informs the queue manager by updating the number of “confirmed” acquisitions. Each robot deactivates itself after performing its task.

The queue manager is responsible for updating a status board where a user can learn the status about his job requisition. The status board displays information for each job requisition, and the queue manager updates this status board with information provided by the robots.

The server, according to the present invention, also supports manual data entry through its manual intervention interface (MANI). The MANI allows human operators to manually enter job requisitions in the few special target web sites that may have different data entry requirements. The MANI is also useful when the user provided information is not accurate and needs to be adjusted by human operators. One example of MANI use is to adjust the address provided by the user when the address is recognized by the targeted web sites. This manual data entering process is transparent to users, except to the extent the status board displays status information in a less timely fashion.

The present invention enables the data entry robots to enter data through the same screen as a human, and thus reducing the complexity of career placement web sites and eliminating the need for these web sites to develop “batch feed” technology that is used usually by users who have a larger number of information for posting.

### DESCRIPTION OF DRAWINGS

The foregoing and other aspects and advantages will be better understood from the following detailed description of a preferred embodiment of the invention with reference to the drawings, in which:

FIG. 1 depicts system architecture according to one embodiment of the present invention.

FIG. 2 depicts block diagram of software components in a server according to one embodiment of the present invention.

FIG. 3 depicts a user process for posting a job requisition.

FIG. 4 depicts a server process for posting a job requisition.

### DETAIL DESCRIPTION OF THE INVENTION

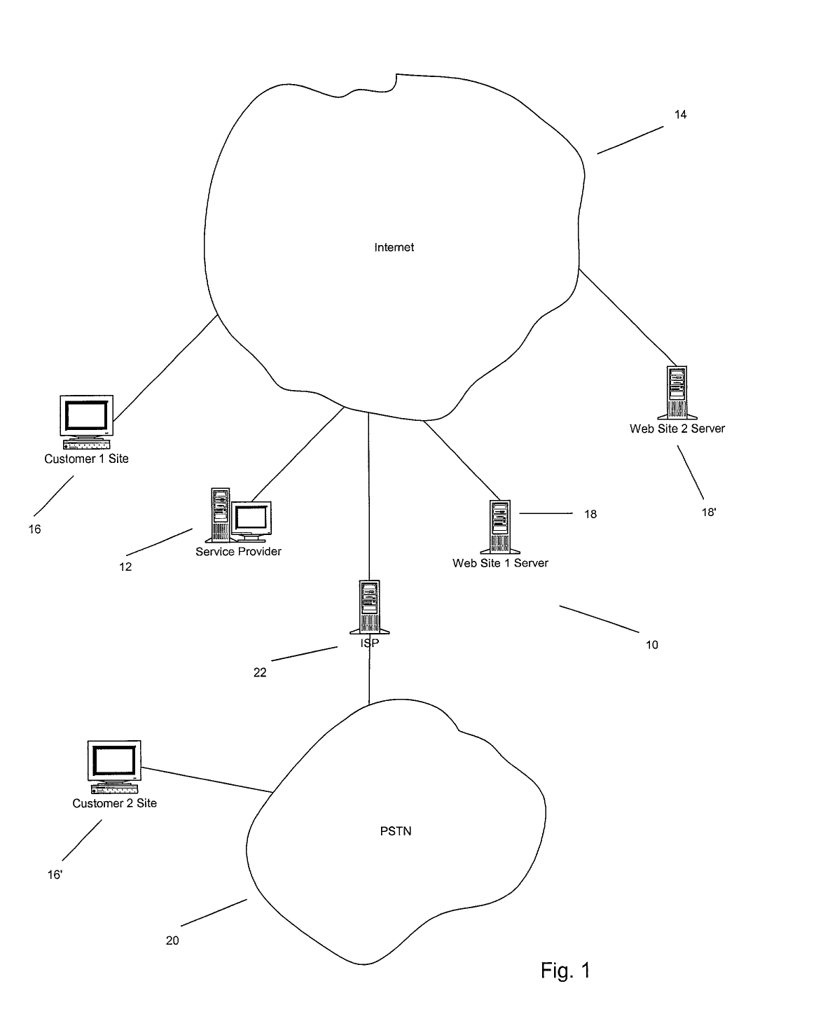

Referring now in greater details to the drawings, in which like numerals represent like components throughout several views, FIG. 1 depicts a system 10 that has a server 12. The server 12 provides the service of posting a job requisition submitted by a user to a plurality of selected web sites supported by different web servers 18, 18′. The server 12 hosts a web site and is accessible through the Internet 14. A user 16 can access the server 12 web site by using a computer connected to the Internet 14. The user 16′ can also use a standalone computer that connects to the Internet 14 by dialing through a public switched telephone network (PSTN) 20 and an Internet service provider (ISP) 22.

When a user has a job opening and wants to get resumes from qualified candidates, the user can post his job requisition on individual career placement web sites 18, 18′ or use the service provided by the server 12. By posting once on the server 12 and specifying which web sites the job requisition information should appear, the user can be ensured that his job requisition will be posted properly by the server 12. The server 12 in accordance to the present invention is capable of checking the job requisition information for conformance to a defined standard and posting the job requisition in a plurality of career placement web sites selected by the user.

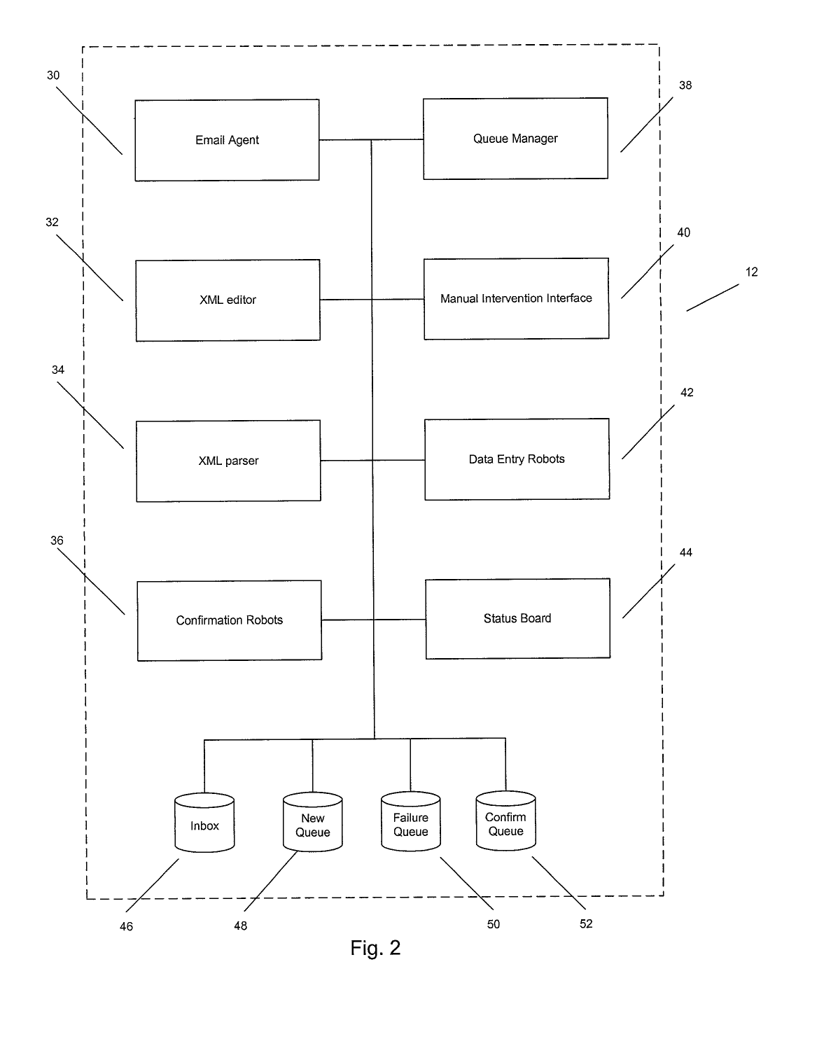

FIG. 2 illustrates block diagram of software components inside the server 12. Besides the software components shown in FIG. 2, the server 12 also possesses necessary elements to host a web site with web pages that accepts information from users. It is shown the following specialized software components: an e-mail agent 30, an XML editor 32, an XML parser 34, confirmation robots 36, a queue manager 38, a manual intervention interface 40, data entry robots 42, a status board 44, an inbox 46, a new queue 48, a failure queue 50, and a confirm queue 52.

The e-mail agent 30 detects incoming job requisitions and starts the handling process. The XML editor 32 checks the job requisitions for formatting errors before passing them to the XML parser 34. The XML parser 34 verifies the content of the job requisitions. When the job requisitions are free of errors, they are ready for posting.

The queue manager 38 coordinates the posting effort across multiple career placement web sites that the user has selected. The queue manager 38 reads the job requisition to ascertain how the job requisition is to be processed: to what web site it is to be posted, to what web site it is to be confirmed, whether it requires manual intervention (MANI software), etc.

After ascertaining the tasks, the queue manager 38 dispatches data entry robots 42 for posting the job requisition on different web sites and confirmation robots 36 for verifying the job requisition has been posted properly. The data entry robots 42 and confirmation robots 36 function much like human operators. The data entry robots 42 are specialized software agents and capable of sending and receiving HTTP messages. The data entry robot 42 can request and interpret web pages from different web sites. The data entry robot 42 can scan web pages from different web sites and learn input data requirements for each site. The data entry robot 42 records the input data requirements for each web site into a task list for that web site. When a data entry robot 42 is equipped with a task list for a specific web site, it becomes the specialized data entry robot 42 for that specific web site. The confirmation robots 36 are similar to the data entry robots 42, but they are equipped with different task lists. The data entry robots 42 and confirmation robots 36 can handle messages in Hyper Text Markup Language (HTML) or other suitable languages used for Internet messages. Each data entry robot 42 is designated for a specific web site. For example, a data entry robot 42 for Headhunter.com, and another data entry robot 42 for Hotjobs.com. Each data entry robot 42 is familiar with data entry requirements of a particular career placement web site. If a data entry robot 42 encounters difficulties while posting a job requisition, human operators can intervene through the manual intervention interface 40.

If there are web sites where automatic data entry is not easily accomplished, the server 12 provides manual data entry through its manual intervention interface (MANI) 40. This manual intervention interface 40 allows human operators to manually enter the job requisition on any individual web sites. The manual intervention interface 40 is especially useful when a user entered geographic location is not recognized by a target web site. The manual intervention interface 40 allows a human operator to match manually a user-entered address to an address that the target web site recognizes and accepts.

While a job requisition is being processed by diverse components of the server 12, it moves through several temporary storage containers. The job requisition passes through the inbox 46, the new queue 48, the confirm queue 52, and optionally the failure queue 50.

Finally, the user can check the status of his job requisition posting on the status board 44. The status board 44 is a component showing all activities. For each job requisition, the status board shows status of posting, confirmation, time data entry robots are launched, time confirmation robots are launched, title of job requisition, and target web site to which the job is posted.

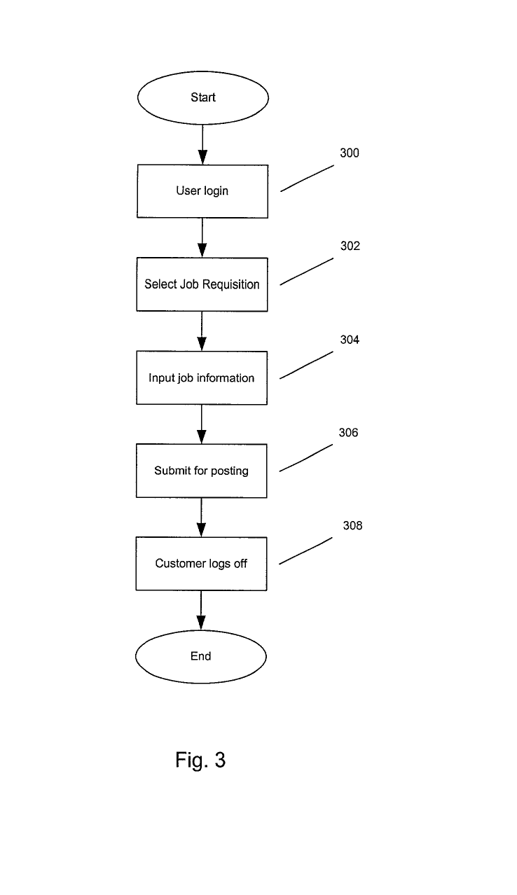

FIG. 3 illustrates a user process for posting a job requisition on multiple career placement web sites by using the server 12. When a user has a job opening, he can use the server 12 to place his job requisition on multiple web sites, instead of visiting the web sites individually and entering the same information multiple times.

The process starts with the user accessing and logging into the web site, step 300. If the user is not a registered user and does not have a login, the user needs to register and obtain a login. The registering procedure is well known to those skilled in the art and not described here. After logging in, the server 12 displays a menu with several actions for the user to choose. The user can choose posting job requisitions, checking job requisition status, checking account status, etc. For posting job opening information, the user selects job requisition, step 302.

In the job requisition procedure, the user can select which web sites to post his job requisition in addition to specifying qualification of candidates. Multiple input screens ask the user to enter information regarding his job requisition. Some of the information are mandatory, while others may be optional. The user inputs information regarding the job requisition, step 304, and selects the career placement web sites where the job requisition is to be posted. After entering the information, the user submits the information for processing, step 306, and logs off, step 308. The user can return later to check the status of his job requisition.

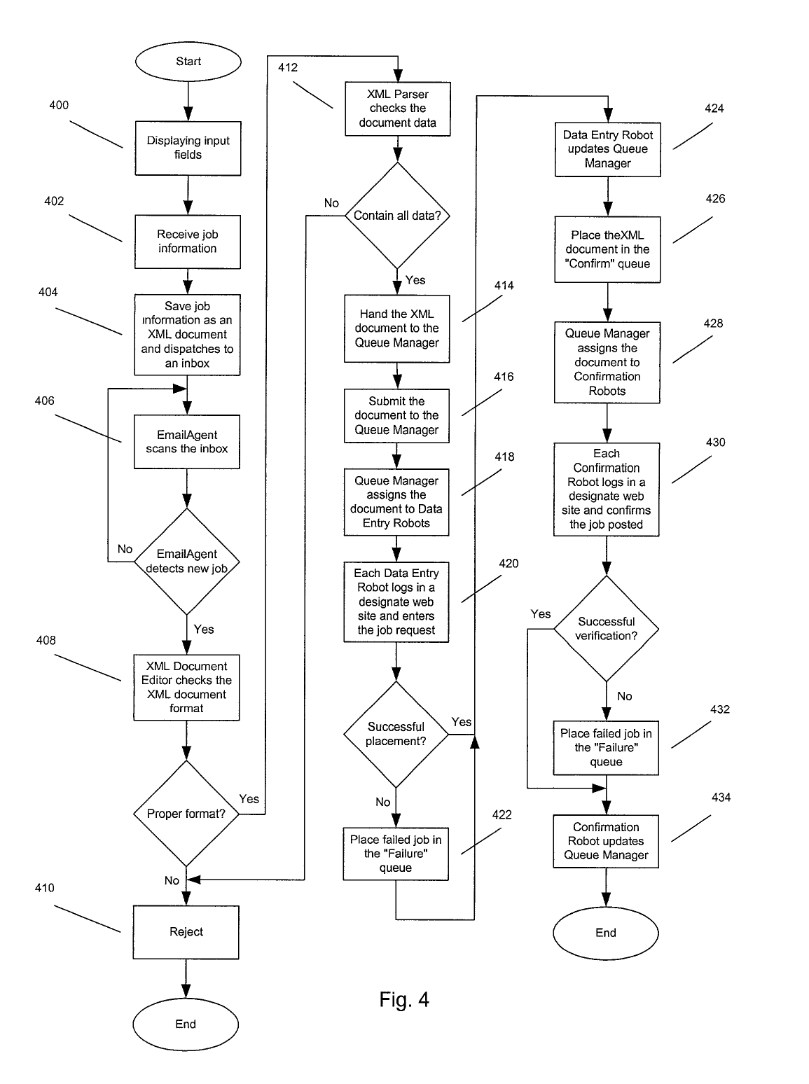

FIG. 4 illustrates a server process for posting user entered information on multiple web sites specified by the user. After the user logs in and selects job requisition, the server 12 displays input screens¹ for the user to enter job requisition information, step 400. The web site for a user to enter job requisitions needs not be supported by the same server that has all software components of FIG. 2. The server receives job requisition information entered by the user, step 402, saves the information in a XML format document and dispatches it via e-mail to an inbox 46, step 404. ¹ In a distributed computing environment, the display is done actually by a client (user) device. However, for the purpose of this description, it will be described as being displayed by the server.

The e-mail agent 30 scans periodically the inbox 46, step 406. If the e-mail agent 30 detects a job requisition in the inbox 46, it notifies the XML editor 32. Alternatively, the inbox 46 can be designed to have some intelligence and capable of notifying the XML editor 32 when ajob requisition is placed in the inbox 46.

The server 12 checks the job requisition entered to ensure it follows the proper format and has the right information. The XML editor 32 receives the job requisition from the inbox 46 and checks the job requisition, which is a XML document, to determine if the XML document has arrived in the properly formatted specification, step 408. If the incoming content deviates from established specifications, it is rejected, step 410, and an e-mail notification is sent to human operators. The notification may contain error messages and suggested corrective actions. If the job requisition is in the right format, the XML parser 34 checks to see if the job requisition contains valid data and ready for submission to the queue manager 38, step 412. The XML parser 34 checks fields for XML tags and/or values within a defined range and makes sure that no essential fields are left blank. The XML parser 34 also checks the job requisition to determine which web site or collection of web sites are to be populated by the data entry robots 42. If the job requisition does not have the valid data, i.e. the job requisition has data missing from required fields, the XML parser rejects it, step 410, and sends an e-mal notification to human operators. After the job requisition passes these tests, it is handed to the queue manager 38 for posting, step 414.

The queue manager 38 coordinates efforts for posting the job requisition on different web sites. The queue manager 38 places newly received job requisition into the new queue 48, step 416, and launches data entry robots 42 to various target web sites to perform data entry tasks, step 418. The queue manager 38 launches an individualized data entry robot 42 per web site. The individualized data entry robot 42 knows the data entry requirements for a particular web site and enters the information accordingly. For example, if the user chooses to post his job requisition in Hotjobs.com and Careersite.com, then one data entry robot dedicated for Hotjobs.com and one data entry robot dedicated for Careersite.com will be launched.

The queue manager 38 can launch more than one individualized robot 42 per a particular web site, i.e., it can launch two or more data entry robots 42 for Hotjobs.com if there are multiple job requisitions for posting at Hotjobs.com. Multiple data entry robots 42 uses the same user identification code and password to access the particular web site simultaneously, if that particular web site permits such simultaneous multiple access. This multiple access speeds up the posting procedure.

If the career placement web site designated by the user does not have an individualized data entry robot, then the job requisition is rejected for this automated process and is placed in the manual intervention interface 40 for human operator handling. The queue manager 3 8 then sends a notification to human operators and starts a process to create a specialized task list for that career placement web site.

The individualized data entry robot 42 “travels” to the designated web site, logs in, and enters the job requisition information, step 420. The data entry robot 42 travels to the designated web site by sending a HTTP message to the web site's URL address, or an otherwise formatted message, to the designated web site requesting data entry forms or web pages. The data entry robot 42 logs in by filling out a message with proper login information and sending the message back to the designated web site. Finally, the data entry robot 42 inputs the job requisition information according to the requirements of the web site. If the data entry robot 42 encounters problems during the data entering process and cannot post the job requisition properly, the data entry robot 42 places the job requisition in the failure queue 50, step 422. The job requisition in the failure queue 50 is rescheduled. If the rescheduled posting operation fails, the job requisition is brought to the attention of human operators through e-mail notification or other suitable means. After the successful posting, the data entry robot 42 updates the queue manager 38 to reduce the number ofjob requisitions to be done and increment the number of job requisitions completed, step 424.

Upon learning the job requisition has been data entered, the queue manager 38 places the job requisition in the confirm queue 52, step 426. The queue manager 38 then launches individualized confirmation robots 36 to travel to each web site and to verify the posted information, step 428. Similarly, the confirmation robots 36 are individualized to one particular site, and capable of following the login instruction of an assigned web site and retrieving posted information. The confirmation robots 36 travel and log in on each web site in a manner similar to the data entry robots 42.

The confirmation robot 36 travels to an assigned web site, logs in, and searches for the posted job requisition, step 430. The search may use a confirmation number provided by that particular web site for each successful posting. Job titles or company names can also be used for the search. If the confirmation robot 36 encounters problems during the verification procedure, the job requisition is placed in the failure queue 50, step 432, and the job requisition is rescheduled for posting. Upon successful verification, the confirmation robot 36 updates the queue manager 38 by incrementing the number of job requisitions successfully confirmed and reducing the number of job requisitions to be confirmed, step 434.

The queue manager 38 is responsible for updating the status board 44. For each job requisition, the queue manager 38 updates the status (whether it is posted or confirmed), records the job requisition number, list the target web sites where the job requisition is to be posted, records the time and date when it launched data entry robots and confirmation robots, and records the time and date when the job requisition is viewable on the target web sites. The queue manager 38 can also provide hyperlinks to postings on each web site, and the customers can visit their job postings by clicking on the hyperlinks.

The service provided by the server 12 is not limited to posting job requisitions in diverse web sites. The server 12 can also be used to update existing data to the database of multiple web sites or to remove a particular job requisition from one or several web sites. A useful application for the server 12 is to support maintenance of a distribute database system, where information resides on several database files distributed geographically. An example of this application is the maintenance of employee information in a large company, where an employee's information is kept by the personnel department, by the employee benefit department, and by the corporate division where the employee works. When there is a status change for the employee, the server 12 can automatically update all the records in different databases throughout the company by dispatching data entry robots 42 and data confirmation robots 36 to different databases.

In an alternate embodiment, a requesting server that does not have all the software components shown in FIG. 2 can support web sites that gather the data from users. This requesting server encapsulates the job requisition information into a XML document and sends it via e-mail to a serving server configured according to the present invention. The e-mail can include user name, password, etc. If there is any information missing, then the serving server can notify the requesting server so that corrective actions may be taken.

In yet another alternate embodiment, a user may request the job requisition information not be displayed on the status board, but instead mail to him. The status information can be mailed in different industry standard formats.

In yet another alternate embodiment, the server 12 may save job requisitions in a format other than XML, and editor 32 and parser 34 can handle job requisitions saved in other formats.

The foregoing description of the preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated.

What is claimed is:

1. A system for receiving information from a user, posting at least part of information received on multiple computer network sites, and verifying the posted information, the system comprising:
an e-mail agent for receiving information from the user;
a document parser for checking the content of the information received;
a queue manager for placing the information received in a queue;
a data entry robot for posting at least part of the information received on a plurality of computer network sites; and
a data verification robot for verifying the posted information on said plurality of computer network sites.

2. The system of claim 1 further comprising a document editor for checking the format of the information received.

3. The system of claim 1 further comprising a manual interface for providing manual posting procedure.

4. The system of claim 1 further comprising a status board for showing status of information posting on computer network sites.

5. The system of claim 1 wherein said data entry robot is capable of requesting information from the plurality of computer network sites, logging onto the plurality of computer network sites, and inputting information onto the plurality of computer network sites.

6. The system of claim 5, wherein said data entry robot is further capable of receiving messages from the plurality of computer network sites, and analyzing the messages received.

7. The system of claim 1 wherein said data verification robot is capable of logging onto the plurality of computer network sites, and requesting information from the plurality of computer network sites.

8. The system of claim 7, wherein said data verification robot is further capable of receiving messages from the plurality of computer network sites, and analyzing the messages received.

9. A computer software program residing in a computer memory inside a server, the computer software program comprising:
program instructions for receiving information from a user;
program instructions for checking the format of the information received;
program instructions for posting at least part of the information received on a plurality of computer network sites; and
program instructions for verifying the posted information on said plurality of computer network sites.

10. The computer software program of claim 9 further comprising:
program instructions for checking the content of the information received; and
program instructions for moving the information received into a waiting queue.

11. The computer software program of claim 9 further comprising program instructions for providing a manual posting procedure.

12. The computer software program of claim 9 further comprising program instructions for showing statuses of the information received.

13. The computer software program of claim 9 further comprising program instructions for
requesting web pages from the plurality of computer network sites, and
sending login information to the plurality of computer network sites.

14. The computer software program of claim 13 wherein programs instructions for
posting further comprising program instructions for inputting at least part of the information received into a message, and
sending the message to the plurality of computer network sites.

15. A method for receiving information from a user, posting at least part of information received on multiple computer network sites, and verifying the posted information, the method comprising:
receiving information from the user;
checking the content of the information received;
placing the information received in a queue;
posting at least part of the information received on a plurality of computer network sites; and
verifying the post information on said plurality of computer network sites.

16 The method of claim 15 further comprising checking the format of the information received.

17. The method of claim 15 further comprising showing status of information posting on computer network sites.

18. The method of claim 15 wherein the posting step further comprises:
requesting information from the plurality of computer network sites,
logging onto the plurality of computer network sites, and
inputting information onto the plurality of computer network sites.

19. The method of claim 18, wherein the posting step further comprises:
receiving messages from the plurality of computer network sites, and
analyzing the messages received.

20. The system of claim 15 wherein the verifying step further comprises:
logging onto the plurality of computer network sites, and
requesting information from the plurality of computer network sites.

21. The system of claim 15, wherein the verifying step further comprises:
receiving messages from the plurality of computer network sites, and analyzing the messages received.
